(19) United States
(12) Patent Application Publication
(10) Pub. No.: US 2026/0253321 A1
(43) Pub. Date: Aug. 27, 2026

(54) MATERIAL GLINT GENERATION FOR DIGITAL CONTENT

(71) Applicant: Adobe Inc., San Jose, CA (US)

(72) Inventors: Tamy Boubekeur, Paris (FR); Theo Thonat, Paris (FR); Lois Paulin, Paris (FR); Jean Marc Christian Marie Thiery, Paris (FR); Pauli Kemppinen, Espoo (FI)

(73) Assignee: Adobe Inc., San Jose, CA (US)

(21) Appl. No.: 19/063,954

(22) Filed: Feb. 26, 2025

(51) Int. Cl. G06T 15/50

(52) U.S. Cl. CPC G06T 15/506

(57) ABSTRACT

Techniques related to material glint generation for digital content are described. In an example, a processing device is operable to obtain a base model representing a material surface of a digital object, receive one or more glint parameters indicating glint effects applied to the material surface, and generate a glint model of the glint effects. The processing device is operable to generate the glint model by integrating a plurality of glint particles within the material surface based on the glint parameters. Using the glint model, the processing device is operable to render an image of the digital object depicting reflections from visible glint particles integrated within the material surface.

### BACKGROUND

Material rendering techniques for digital content simulate realistic surface appearances, including complex light interactions with surface features. Conventional approaches struggle to produce realistic glint effects, e.g., sparkly reflections caused by micro-scale reflective surface geometries of individual anisotropic glints, in a computationally efficient manner. Smooth models simplify surface modeling and improve rendering efficiency. Visual quality and realism suffers from a smooth model inability to represent highly variable surface geometries that cause the subtle variations and randomness in reflections from the individual anisotropic glints. Complex physics simulations are computationally demanding solutions for improving glint realism, which often exceed the preprocessing, data storage, and runtime capabilities of real-world implementations.

### SUMMARY

Techniques using material glint generation for digital content production are described. An example system (e.g., a content processing system) includes a modeling tool that receives input designating a material part of a digital object and obtains glint parameters indicating glint effects to be applied to the material surface. The digital object is represented by a base model, for example, which models the material surface of the digital object including the material part designated by the input. The glint parameters convey visual phenomena that simulate localized reflections or sparkles resulting from embedded particles within the material surface. The modeling tool generates a glint model by representing a plurality of glint particles integrated within the material surface based on the glint parameters and the base model.

In variations, the glint model supports efficient glint particle processing without explicitly storing each particle position and orientation. Instead, the glint model uses a procedural approach where particle properties are generated on-the-fly based on implicit grid cell indices. The modeling tool defines grid structures at multiple fixed scales. Two of the fixed scales are considered for shading each pixel at runtime. Each pixel depicts a surface at a particular scale, and the modeling tool picks, for each pixel, two of the multiple fixed scales that are nearest to that pixel scale. An implicit four dimensional (4D) grid structure is defined around the pixel to have two dimensions representing spatial distributions of the glint particles at each of the two fixed scales, and two dimensions representing angular distributions of the glint particles at each of the two fixed scales. At runtime, the modeling tool procedurally generates the glints on the implicitly defined 4D grid structure based the implicit grid cell indices at corresponding camera distances and geometric orientations. Further, the modeling tool directly produces anti-aliased output, emulating the usage of post-processing pixel filters without the computational cost, resulting in efficient and aliasing-free composite renderings that incorporate the glints. Using the glint model, the modeling tool renders an aliasing-free image of the digital object depicting reflections from visible glint particles integrated with reflections from the material surface overall.

This approach to glint generation enables efficient and realistic simulation of complex micro-scale reflective features that are challenging to represent using conventional modeling techniques. In variations, the modeling tool outputs glint previews showing reflections from visible glint particles integrated within the material surface. In some aspects, the system receives user inputs requesting glint previews at different viewing angles or distances relative to the material surface. The modeling tool is configured to output updated glint previews responsive to the user inputs, depicting reflections from different visible glint particles. This allows for interactive adjustment and visualization of glint effects from various perspectives, addressing limitations of conventional approaches that struggle to apply consistent glint effects across different scenes and viewing conditions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description includes references to the accompanying figures. Entities represented in the figures are indicative of one or more entities and thus reference is made interchangeably to single or plural forms of the entities in the discussion.

FIG. 1 illustrates a block diagram of an example environment implementing for material glint generation for digital content, according to aspects of the present disclosure.

FIG. 2a depicts a block diagram of an example modeling system implementing material glint generation for digital content, according to aspects of the present disclosure.

FIG. 2b depicts a block diagram of an example glint effect system implementing material glint generation for digital content, according to aspects of the present disclosure.

FIG. 3 illustrates a block diagram of an example implicit grid structure used to implement material glint generation for digital content, according to aspects of the present disclosure.

FIG. 4 demonstrates a comparison between material surface representations depicting non-glint and glint characteristics, according to aspects of the present disclosure.

FIG. 5 illustrates example glint effects applied to an object model using material glint generation for digital content, according to aspects of the present disclosure.

FIG. 6 illustrates a flowchart of a process for using material glint generation for digital content, according to aspects of the present disclosure.

FIG. 7 illustrates a flowchart of another process for using material glint generation for digital content, according to aspects of the present disclosure.

FIG. 8 shows an example system including various components of an example device usable as any type of computing device as described and/or utilized with reference to FIGS. 1-7 to implement examples of the techniques described herein.

### DETAILED DESCRIPTION

### Overview

Inaccurate glint rendering affects the perceived realism of materials depicted by digital content, such as car paint, metallic fabrics, or natural surfaces. Conventional glint rendering approaches strain to produce realistic glint effects in a computationally efficient manner, presenting challenges when integrating with high performance interactive three dimensional (3D) environment simulations and seemingly real-time rendering scenarios. As display technologies advance and viewers expect more nuanced and accurate material rendering of subtle effects like glints and sparkles, sluggish glint rendering performance is more apparent.

In various real-time applications, such as modeling and rendering tools that preview adjustments to viewing angles, camera positions, and lighting conditions, conventional glint rendering involves constructing glint specific procedural materials to produce surface information directly for rendering without searching for reflection spikes using acceleration structures. Examples include adding glint effects as a post-hoc modification to existing Bidirectional Reflectance Distribution Functions (BRDFs) and constructing explicit Normal Distribution Functions (NDFs) for creating glint material specific BRDF models. BDRFs are mathematical models that describe surface reflectance as a ratio of reflected radiance to incident irradiance for incoming and outgoing directions, with noticeable accuracy modeling smooth reflections. Challenges arise when using BRDFs for modeling materials with micro-scale reflective features like glints, which produce discrete sparkles with distinctly different behavior than smooth reflections. Conventional BRDF models often struggle to capture the complex reflection behavior of glints. Without significant memory and computation time, realism of dynamic and view-dependent variations of anisotropic glint effect renderings deteriorates in response to changing camera and lighting conditions.

An example system (e.g., a content processing system) implements material glint generation techniques for digital content production. The system enables efficient and realistic simulation of complex micro-scale reflective features to implement glint effects (e.g., sparkles, glittery reflections) that are challenging to represent using conventional modeling techniques. The system is operable to receive input designating a material part of a digital object and obtain glint parameters indicating glint effects applied to the material surface.

The digital object is represented by a base model, for example, which models the material surface of the digital object including the material part designated by the input. For example, the base model is a BRDF type model of a material surface. The glint parameters describe visual phenomena associated with a particular style of localized reflections or sparkles resulting from embedded particles within the material surface. From the base mode, the system generates a glint model that represents a plurality of glint particles based on the glint parameters integrated within the material surface modeled by the base model. The system modifies an NDF of the BRDF, for instance, by introducing high-frequency variations in the NDF indicative of each of the glint particles. The approach allows the system to maintain compatibility with existing physically-based rendering workflows by preserving existing BRDF structures while improving realism through introduction of realistic and dynamic anisotropic glint effects. The system adjusts particle characteristics represented by the glint model (e.g., the NDF), such as glint density, color, roughness, and distribution pattern, based on the input glint parameters, providing fine-grained control over the anisotropic appearance of the glint effects. By integrating seamlessly with existing (e.g., BRDF) pipelines while maintaining efficiency and scalability, the system supports a more nuanced and accurate material rendering result.

To improve versatility, as well as processing efficiency, the glint model supports efficient glint particle processing for rendering pixels, without explicitly storing each particle position and orientation. Instead, the glint model uses a procedural approach where particle properties are generated during rendering processes (e.g., on-the-fly, in seemingly real-time) procedurally based on particle information obtained from implicit grid cell indices. The system implicitly defines grid structure at multiple fixed scales (e.g., multiple levels of detail). Two of the fixed scales are locally chosen for shading each pixel, at runtime, based on pixel camera distances and potential surface orientations. Each pixel depicts a surface at a particular scale, and the system picks, for each pixel, two of the multiple fixed scales that are nearest to that pixel scale. Each fixed scale has two corresponding dimensions representing either spatial or angular distributions of the glint particles visible at that scale. For example, the system implicitly defines a 4D grid structure around the pixel to have two dimensions representing spatial distributions of the glint particles at two fixed scales, and two dimensions representing angular distributions of the glint particles at the two fixed scales.

The glints are procedurally generated by the glint model during rendering by converting a camera distance and surface orientation into implicit grid cell indices for defining a corresponding group of visible glint particles at a pixel. At runtime, the glint model procedurally generates the glints on the implicitly defined 4D grid structure to account for the correct level of detail requested by a rendering pipeline. In variations, to blend progressively between the two different scales considered locally, the glint model implements a roulette feature. The roulette feature configures the glint model to select a correct quantity of procedural glints from each fixed scale to blend together and enable efficient progressive level-of-detail management at each possible level of detail, including in between the fixed scales.

The system processes the glint model to render an image of the digital object depicting reflections from visible glint particles integrated within the material surface. The processing involves applying the glint model to use the implicit grid structure to calculate how light interacts with glint particles visible at different virtual camera angles and distance scales. The rendered image displays the processed digital object with realistic glint effects that vary based on viewing angle and distance. An output from the system enables more efficient and accurate representation of materials with micro-scale reflective features, addressing limitations of conventional physically-based rendering workflows that do not fully account for subtle glint variations. Further, the modeling tool directly produces anti-aliased output, emulating the usage of post-processing pixel filters without the computational cost, resulting in efficient and aliasing-free composite renderings that incorporate the glints.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Production Environment

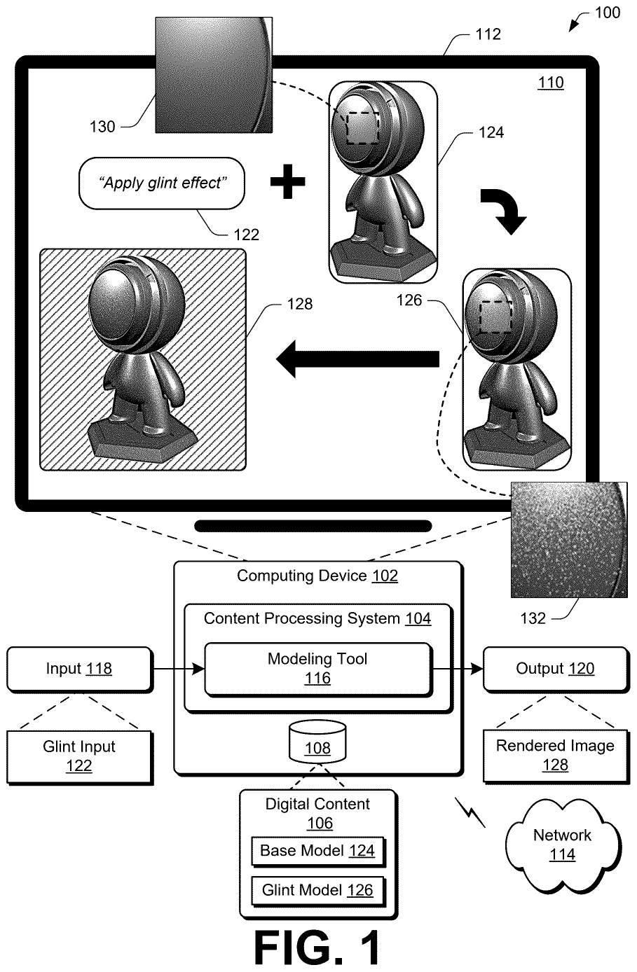

FIG. 1 is an illustration of a digital medium environment 100 in an example implementation that is operable to employ techniques described herein related to material glint generation for digital content. The environment 100 includes a computing device 102, which is configurable in a variety of ways.

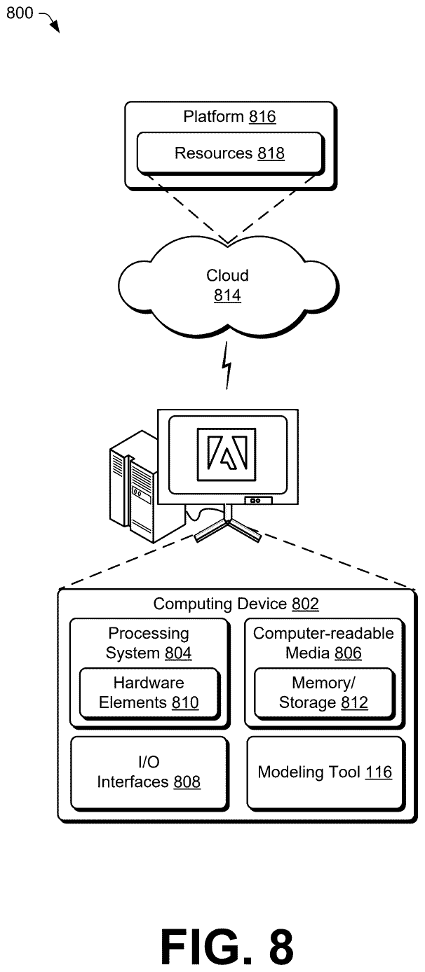

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 8.

The computing device 102 is illustrated as including a content processing system 104. The content processing system 104 is implemented at least partially in hardware of the computing device 102 to process and transform digital content 106, which is illustrated as being maintained in storage 108 of the computing device 102. Such processing includes creation of the digital content 106, modification of the digital content 106, and rendering or re-rendering of the digital content 106 for presentation in a user interface 110, e.g., for output by a display device 112. Although illustrated as implemented locally at the computing device 102, functionality of the content processing system 104 is also configurable in whole or in part through functionality available via the network 114, such as part of a web service or “in the cloud”.

An example of functionality incorporated by the content processing system 104 for processing the digital content 106 is illustrated as a modeling tool 116. The modeling tool 116 is configured to execute complex data processing tasks by receiving input 118 and generating output 120. The modeling tool 116 analyzes the input 118 to perform material glint generation for 3D objects. Configured to adjust a glint normal distribution function and define an implicit multi-dimensional grid structure to integrate glint particles that exhibit accurate relationships between material properties and glint effects, the modeling tool 116 determines realistic glint representations. Glint models generated by the modeling tool 116 are used to generate renderable glint data, enabling the content processing system 104 to generate glint effects within the digital content 106 for modeling or producing realistic renderings of 3D objects with complex reflective properties.

The input 118 to the modeling tool 116 is depicted as a glint input 122, which includes glint parameters indicating desired glint effects applied to a material surface. The glint parameters specified by the glint input 122 include parameters for adjusting an overall distribution and aesthetic appearance of glint effects across the material surface, such as randomness factors, clustering tendencies, or gradients in glint properties. The glint parameters may include values for controlling the size, shape, orientation, and reflectivity of individual glint particles or aesthetics of a resulting glint effect overall. The glint input 122 designates characteristics such as glint density, color, roughness, angular and spatial distribution patterns, or other properties that convey visual phenomena of glint effect by simulating localized reflections or sparkles resulting from embedded particles within the material surface. For example, the glint input 122 describes a “metallic car paint with fine, dense glints” or “sequined fabric with scattered, intense glints.”

The modeling tool 116 processes these detailed glint parameters with reference to a base model 124. The base model 124 represents a variety of 3D objects such as vehicles, clothing, jewelry, or other items with potentially reflective or glittery surfaces. The base model 124 is representable in various 3D formats such as polygon meshes, NURBS surfaces, or other geometric representations. The base model 124 is received via the input 118 in some examples, and in variations, the base model 124 is loaded from the data storage 108, received via the network 114, or obtained in other ways.

The glint input 122 is applied to the base model 124 designating a material surface of a digital object. The modeling tool 116 generates a glint model 126 that accurately represents the reflective characteristics specified by the glint input 122 when applied to the material surface designated on the base model 124. For example, the modeling tool 116 generates the glint model 126 by mapping a plurality of glint particles based on the glint input 122 that are visible on the material surface of the base model 124 to an implicit 4D grid structure that represents the glint particles in two scales (e.g., different levels of detail). Two of the four dimensions each define a respective spatial distribution of the glint particles at a different corresponding scale. The other two dimensions each define a respective angular distribution of the glint particles at a different corresponding scale.

To blend progressively between the different scales, a roulette feature is implemented by the glint model 126. The roulette feature configures the glint model 126 to select a correct quantity of procedural glints from each scale to enable efficient and balanced progressive level-of-detail management at each possible level of detail. The implicit grid approach allows the modeling tool 116 to trade off spatial and angular resolution in a computationally efficient manner and without utilizing storage, addressing challenges that other models have supporting seemingly real-time glint rendering across different viewing conditions without exceeding the preprocessing, data storage, and runtime capabilities of real-world implementations.

In at least one example, the modeling tool 116 derives the glint model 126 from a BRDF associated with the base model 124. The system modifies the NDF of the BRDF by introducing high-frequency variations to represent each of the glint particles. The approach allows the modeling tool 116 to maintain compatibility with existing physically-based rendering workflows while improving realism by introducing more realistic and varied glint effects. The modeling tool 116 adjusts particle characteristics represented by the NDF of the glint model 126, such as glint density, color, roughness, and distribution pattern, based on the input glint parameters, providing fine-grained control over the appearance of glint effects.

By integrating seamlessly with existing BRDF pipelines while maintaining efficiency and scalability, the modeling tool 116 supports a more nuanced and accurate material rendering in advanced display technologies and computer graphics applications. The modeling tool 116 enables the content processing system 104 to generate material glint effects that enhance the visual quality and realism of digital content, overcoming challenges of other approaches in accurately representing micro-scale reflective features in a computationally efficient manner.

The output 120 generated by the modeling tool 116 includes a rendered image 128 depicting the digital object with glint effects. The rendered image 128 shows reflections from visible glint particles integrated within the material surface, providing a realistic representation of complex micro-scale reflective features. The modeling tool 116 processes the glint model 126 to render the image 128 by applying the glint model 126 to the base geometry and surface properties to calculate how light interacts with the glint particles at different angles and scales.

The user interface 110 enables users to interact with the content processing system 104, view the base model 124 and glint model 126, and provide feedback. FIG. 1 shows the user interface 110 presenting a zoomed base model view 130 and a zoomed glint model view 132, demonstrating the difference between the original surface and the surface with applied glint effects. Users manipulate the base model 124 and glint model 126 using various controls, with the glint input 122 indicating user interaction for specifying glint parameters.

The glint model 126 enables the modeling tool 116 to seamlessly integrate alias-free contributions of glint effects generated by the glint model 126 with alias-free contributions of other, non-glint lighting effects output from the modeling tool 116. By including the glint effect contributions being alias-free, the modeling tool 116 is operable to quickly render and re-render different views of the glint effects applied to the base model 124. For example, the modeling tool 116 is configured to output a rendering preview, such as the user interface 110, showing reflections from visible glint particles integrated within the material surface shaped by the base model 124. The modeling tool 116 receives user inputs from the user interface 110 requesting glint previews at different viewing angles or distances relative to the material surface, and the glint model 126 enables the modeling tool 116 to support interactive adjustment and visualization of glint effects from various perspectives of the base model 124. The interactive capability embedded in the user interface 110 improves usability to increase adoption across a wide range of applications.

The environment 100 implements material glint generation in digital content by using the modeling tool 116 to process input 118 and produce renderings with glint effects. The content processing system 104 processes the glint input 122 to create the glint model 126 and generate the rendered image 128, providing a visual representation of the glint effects. The modeling tool 116 improves computational efficiency by defining implicit grid structures that support procedural generation of visible glint particles and corresponding reflection characteristics without occupying storage with information about the individual glints. This approach enables efficient and versatile simulation of complex micro-scale reflective features to improve realistic renderings of complex light interactions from glints, which are challenging to represent using other modeling techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture of Material Glint Generation

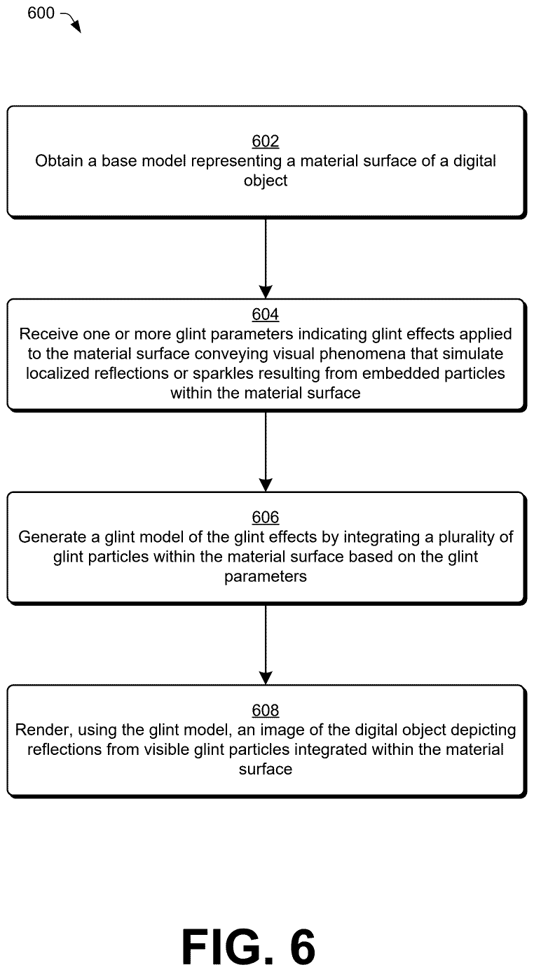

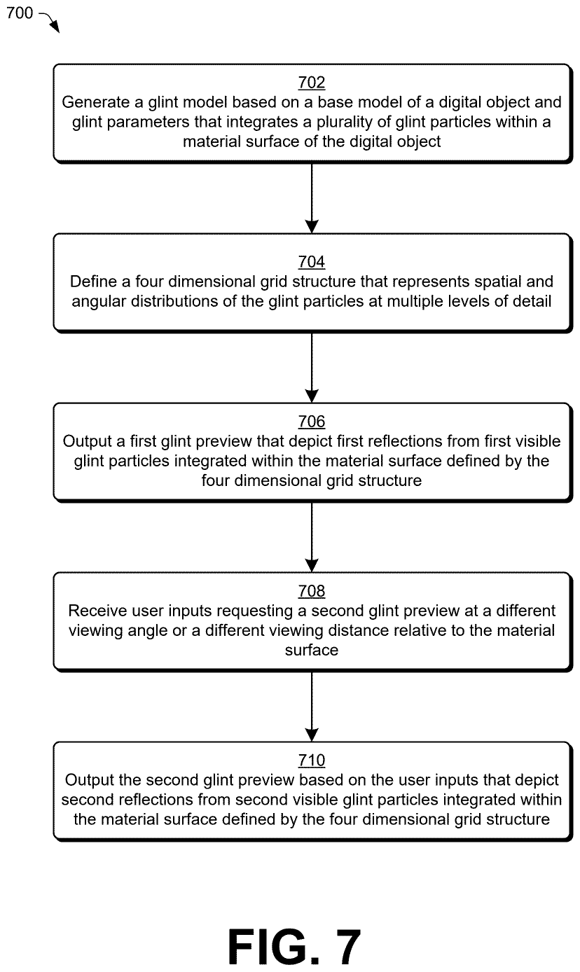

The following discussion describes material glint generation for digital content techniques that are implementable utilizing the previously described systems and devices. Aspects of each of the processes, e.g., as shown in FIGS. 6 and 7, are implemented in hardware, firmware, software, or a combination thereof. The processes are shown as a set of blocks that specify operations performed by one or more devices and are not limited to the orders shown for performing the operations by the respective blocks.

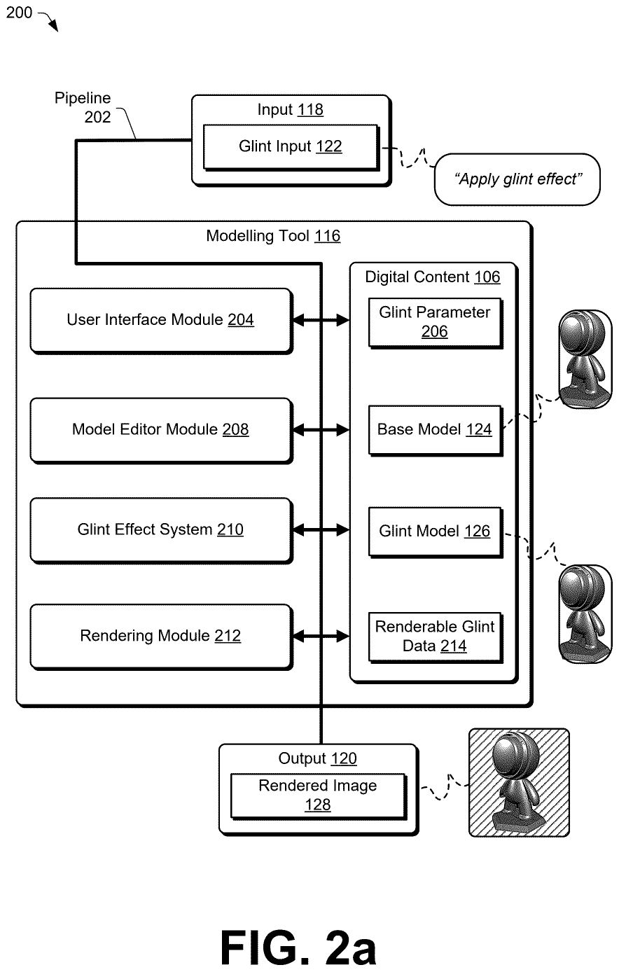

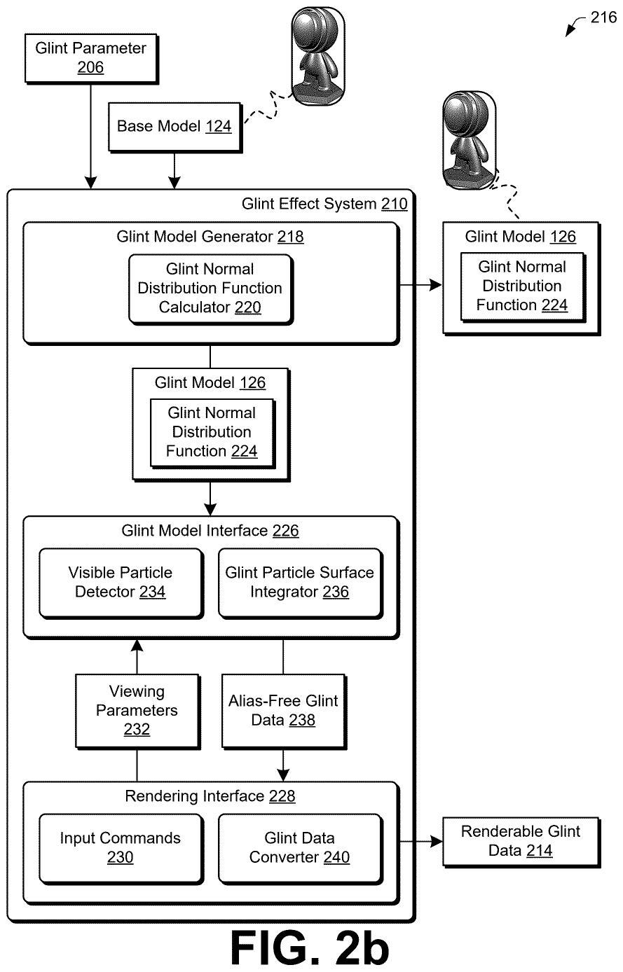

FIG. 2a depicts a block diagram of an example modeling system 200 implementing material glint generation for digital content, according to aspects of the present disclosure. The system 200 illustrates an implementation of the modeling tool 116 within the content processing system 104, shown in greater detail than in FIG. 1.

The modeling system 200 includes a processing pipeline 202 that processes input 118 and generates output 120, demonstrating an example workflow for applying glint effects to material surfaces of 3D models. In one example scenario, a user of the computing device 102 interacts with the modeling tool 116 to select a base model 124, such as a car model with a metallic paint finish. The user then initiates a glint generation process by inputting glint parameters base on a glint input 122 (e.g., specifying “fine, dense glints for metallic car paint”) through the user interface 110. The modeling tool 116 receives the glint input 122 specifying glint parameters as part of the input 118.

The modeling system 200 includes a user interface module 204 that facilitates user interactions as part of managing interactions with the user interface 110 and the modeling system 200, including implementing features that enable manipulation of the base model 124 and observation of the rendered image 128. The user interface module 204 converts user interface selections to glint parameters 206 of the glint input 122. As one example, when a user makes a selection by interacting with the base model 124 displayed in the user interface 110, the user interface module 204 translates the visual selection into text-based glint parameters 206 conveyed by the glint input 122. If a user selects the hood of a car model presented by the display device 112, for instance, the user interface module 204 generates the glint parameters 206 to indicate “fine, dense glints applied to metallic car paint”.

The glint parameters 206 provide a structured representation of user-defined glint characteristics, such as density, roughness, color, and distribution patterns. The glint parameter 206 is accessible to both the model editor module 208 and the glint effect system 210, ensuring consistent application of the glint parameters 206 across different stages of the modeling process. The glint parameter 206 supports various parameter types, including numerical values, categorical options, and spatial maps. For example, the glint parameter 206 stores global parameters like overall glint density, as well as spatially varying parameters that define different glint characteristics across different regions of the model, which allows for complex, heterogeneous glint effects that vary across the surface of a 3D object. The parameters 206 apply to multiple glint particles, not individuals. Additionally, the glint parameter 206 enables parameter validation and normalization to ensure that glint input 122 includes values that are within acceptable ranges and properly formatted for use by other components of the system. Formatting the glint input 122 into the glint parameter 206 helps prevent errors and inconsistencies in the glint generation process, contributing to the overall robustness and reliability of the modeling system 200.

Upon receiving the input 118, the model editor module 208 prepares the base model 124 for processing. The model editor module 208 adjusts the geometry or surface properties of the base model 124 based on the glint parameters 206 inferred from the glint input 122. For example, the model editor module 208 refines the mesh resolution in areas where fine glints are applied or modifies surface normal information to accommodate the glint effects. The model editor module 208 analyzes surface characteristics like density, color, roughness, reflectivity, and curvature to determine appropriate glint particle spatial and orientation distributions. For instance, rougher surfaces may result in a more scattered glint distribution, while smoother surfaces may have more concentrated glint patterns. The reflectivity of the material surface influences the characteristics of glint effects, with highly reflective surfaces producing more prominent glints. The model editor module 208 also considers surface curvature when positioning glint particles, adjusting their orientations to align with the local surface geometry. This approach enables the generation of realistic glint effects that are consistent with the underlying material properties and surface structure of the base model 124.

The glint effect system 210 of the modeling tool 116 transforms the base model 124 and glint parameters 206 into a glint model 126 representing reflection properties of glint particles integrated within a material surface. The glint effect system 210 analyzes the input 118 and the base model 124 to generate the glint model 126. The glint model 126 procedurally generates visible glint particles and calculates contributions to a final rendered image. The glint effect system 210 utilizes a procedural, implicit grid-based approach to manage spatial and angular distributions of the glint particles represented by the glint model 126. The glint effect system 210 generates the glint model 126 by representing a plurality of glint particles integrated based on the glint parameters 206 within the material surface of the base model 124.

The rendering module 212 utilizes the glint model 126 to generate rendered data 214, which includes the rendered image 128. The rendering module 212 interfaces with the glint model 126 to enable efficient rendering of complex glint effects depicted in the rendered image 128.

The user interface module 204 updates the display device 112 and content of the user interface 110 in response to additional instances of the input 118. The system 200 uses the user interface module 204 to provide rapid feedback based on updates to the glint model 126 in response to changes in glint parameters 206 or viewing conditions, allowing the user to interactively adjust and visualize glint effects from various perspectives of the base model 124.

FIG. 2b depicts a block diagram of an example system 216 implementing material glint generation for digital content. The glint effect system 210 is depicted with the system 216 in greater detail than FIG. 2a, and as depicted includes a glint model generator 218 that processes inputs from a glint parameter 206 and a base model 124. The glint model generator 218 includes interconnected components arranged in a processing pipeline to enable generation of glint effects for 3D objects.

As mentioned throughout this disclosure, examples of the base model 124 include BRDF models, and variations of the glint model 126 include modified BRDF parameters including a modified NDF relative to the base model 124. A glint normal distribution function calculator 220 of the glint model generator 218 is executed by the glint effect system 210 to generate a modified NDF as part of the glint model 126, which is labeled in FIG. 2b as a glint normal distribution function 224. For example, the BRDF of the base model 124 includes a diffuse component representing scattered light reflected from a material surface in multiple directions. The BRDF also includes a specular component, a NDF representing reflected light in a specific direction. The glint normal distribution function calculator 220 modifies the specular component of the BRDF of the base model 124 to produce the glint normal distribution function 224 of the glint model 126 representing the glint particles as a statistical distribution of microfacet normal properties on the material surface. The calculator 220 introduces high-frequency variations in the glint normal distribution function 224 for each glint particle. The glint normal distribution function calculator 220 adjusts particle characteristics defined by the glint normal distribution function 224 such as glint density, color, roughness, and distribution pattern based on the glint parameters 206, providing control over the appearance of glint effects.

The glint normal distribution function calculator 220 is configured to modify the NDF of the base model 124 to reflect glints in the glint normal distribution function 224 of the glint model 126. In the illustrated example, the glint normal distribution function calculator 220 employs the Cook-Torrance microfacet model:

$$ρ ( {ω}_{o} , {ω}_{i} ) = \frac{F ( {ω}_{o} , {ω}_{h} ) G ( {ω}_{o} , {ω}_{h} , {ω}_{i} ) D ( {ω}_{h} )}{4 \vert {ω}_{g} \cdot {ω}_{o} \vert \vert {ω}_{g} \cdot {ω}_{i} \vert} \qquad ( 1 )$$

Where F, G and D represent the Fresnel, geometry, and normal distribution functions, respectively, and wₕ=(wₒ+wᵢ)/||(wₒ+wᵢ)|| is the half-vector while w_{g} is the base surface local normal. The glint effect system 210 modifies the Normal Distribution Function (NDF) D of the BRDF by introducing high-frequency variations to each of the glint particles. This is achieved by replacing D with a spatially varying distribution D_{G}(χ, ωₕ) that models a discrete set of reflective particles on the surface. The modified D_G is built so that spatial averages remain constant, thus effectively redistributing the energy of the input smooth NDF D towards the procedurally-generated glints:

$${lim}_{\vert Ω \vert \to ∞} \frac{1}{\vert Ω \vert} {\int }_{Ω} {D}_{G} ( x , {ω}_{h} ) d x = D ( {ω}_{h} ) \qquad ( 2 )$$

Achieving consistently constant spatial averages effectively redistributes the energy of the input smooth NDF D towards constructing the glint normal distribution function 224 and causing the NDF D_{G} to represent the procedurally-generated glints.

The glint normal distribution function calculator 220 computes D_{G} from a standardized particle process D_{G0} with a suitable roughness matrix M:

$${D}_{G} ( x , {ω}_{h} ) = \frac{\vert M \vert}{\vert {M}^{T} {ω}_{h} {\vert}^{4}} {D}_{G 0} ( x , \frac{{M}^{T} {ω}_{h}}{\vert {M}^{T} {ω}_{h} \vert} ) \qquad ( 3 )$$

This transformation allows the glint normal distribution function calculator 220 to generate processes for each of the roughness values, including anisotropic ones. The calculator 220 then maps the microfacet orientations from the uniform hemisphere onto a uniform disk using Lambert's area-preserving azimuthal projection. The glint normal distribution function calculator 220 defines the glint normal distribution function 224 as a mixture of Gaussians:

$${D}_{G 0} ( x , ω ) = {\sum }_{i}^{N} p ( T ( ω ) , {μ}_{i} , {σ}_{0} * \sqrt{{J}_{T} ( ω )} ) δ ( {x}_{i} - x ) \qquad ( 4 )$$

where i ranges over N particles, T is the transformation from hemisphere to disk, μᵢ is the point on the disk corresponding to the microfacet orientation of particle i, χᵢ is its location on the surface, σ₀ is the base standard deviation, and J_{T} is the Jacobian determinant of T. To make the glint normal distribution function 224 practical to evaluate, the calculator 220 convolves the glint normal distribution function 224, resulting in an alias-free glint normal distribution function 224:

$${D}_{G 0} ( x , \sum , {ω}_{h} ) = {\sum }_{i}^{N} p ( T ( {ω}_{h} ) , {μ}_{i} , {σ}_{0} * {J}_{T} ( {ω}_{h} ) ) f ( {x}_{i} - x , \sum ) \qquad ( 5 )$$

where f is the filter and Σ is its 2D covariance matrix. The full resulting NDF is a mixture of Gaussians, transformed from a disk to a hemisphere to a GGX density weighted hemisphere:

$${D}_{G} ( x , {ω}_{h} ) = \frac{\vert M \vert}{\vert {M}^{T} {ω}_{h} {\vert}^{4}} {\sum }_{i}^{N} p ( \frac{{M}^{T} {ω}_{h}}{\vert {M}^{T} {ω}_{h} \vert} , {μ}_{i} , σ ) f ( {x}_{i} - x , \sum ) \qquad ( 6 )$$

The glint normal distribution function calculator 220 adjusts the glint normal distribution function 224 to adjust particle characteristics represented by the glint model 126, such as glint density, color, roughness, and distribution pattern, in response to changes to the glint parameters 206, allowing user control over the appearance of glint effects. For example, the glint normal distribution function calculator 220 processes the glint parameters 206 received at the glint model generator 218 to introduce variations in the glint normal distribution function 224 that increase glint density from one hundred particles per square centimeter to five hundred particles per square centimeter, adjust the glint parameters 206 from 50% reflectivity to 75% reflectivity, and modify the distribution pattern from uniform to clustered with 80% of particles concentrated in 20% of the surface area. Specific adjustments to the glint normal distribution function 224 modify particle characteristics of the glint model 126, enabling fine-tuned control over how glint particles are distributed and oriented across the material surface.

As another example, the glint normal distribution function calculator 220 processes the glint parameters 206 received at the glint model generator 218 by incorporating a compensation term in the glint normal distribution function 224. This compensation term helps maintain overall energy conservation and improves the accuracy of the rendered glint effects across different viewing conditions and scales. In variations, the compensation term accounts for the contribution of particles not considered close neighbors, similar to a gated Bernoulli approximation. The compensation term, if applied to the glint normal distribution function 224, helps the glint normal distribution function calculator 220 configure the glint model 126 to maintain overall energy conservation and improves the accuracy of the rendered glint effects across different viewing conditions and scales.

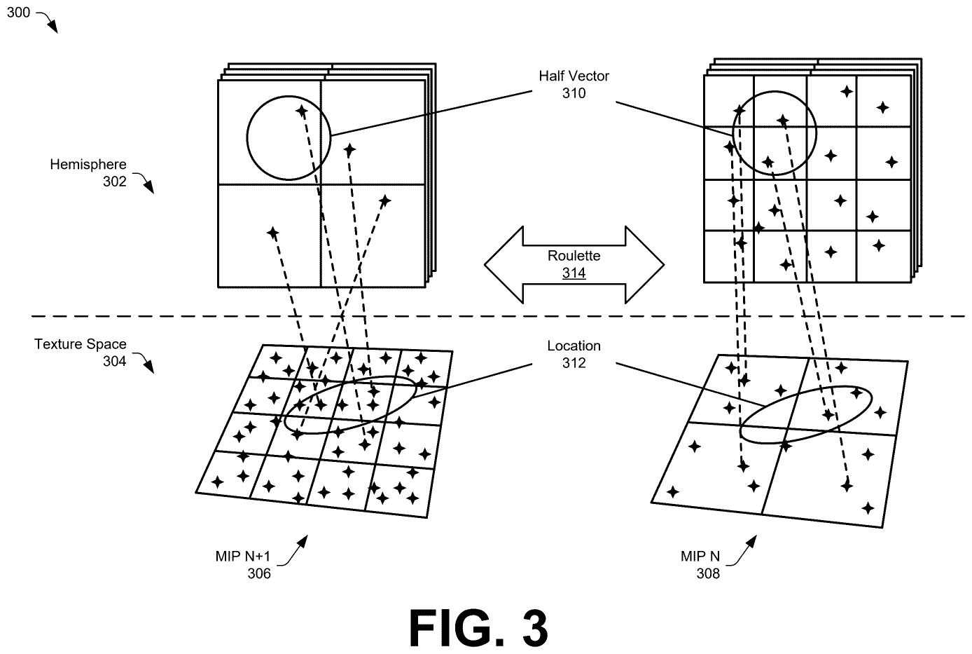

The glint model 126 efficiently represents and supports glint particle processing without explicitly storing each particle position and orientation. Instead, the glint model generator 218 configures the glint model 126 to facilitate a procedural approach where particle properties are generated on-the-fly based on implicit grid cell indices. The procedural approach reduces memory requirements and allows for the representation of numerous glint particles, addressing limitations of approaches that relied on explicit particle storage or pre-computed textures. The procedural approach is described in greater detail below with reference to FIG. 3, with reference to an implicit grid-based approach to achieve consistent glint effects across different viewing conditions.

The glint model 126 also supports the generation and rendering of individually colored glints, enhancing control and realism for materials like multi-colored glitter or iridescent surfaces. For iridescent materials, the color of each glint particle changes dynamically based on the viewing angle, simulating the characteristic color shifts of these materials. In variations, the glint model generator 218 assigns specific color values in the glint normal distribution function for each glint particle, which can vary based on factors such as particle orientation, size, or position.

A glint model interface 226 within the glint effect system 210 is configured to access the glint model 126 to respond to requests for renderable glint data 214, including anisotropic glint effects, allowing for the representation of materials with directional reflective properties such as brushed metals or certain types of fabrics. A rendering interface 228 of the glint effect system 210 is configured to receive input commands 230 to enable adjustment of rendering parameters (e.g., camera angles, camera positions, camera distances, lighting conditions) for generating the renderable glint data 214.

The rendering interface 228 transforms the input commands into viewing parameters 232 for glint effects requested from the glint model 126. For example, the rendering interface 228 processes the viewing parameters 232 to implement importance sampling techniques designed for the glint model 126, enabling efficient rendering of glint effects in scenarios with complex lighting conditions, such as environment map lighting.

The glint model interface 226 includes a visible particle detector 234 and a glint particle surface integrator 236, which collaborate to efficiently produce alias-free glint data 238 for use in rendering complex glint effects without excessive super sampling or explicit ray tracing of individual glint particles. The visible particle detector 234 determines which glint particles modeled by the glint normal distribution function 224 contribute to each pixel described by the viewing parameters 232. In aspects, the visible particle detector 234 adjusts a reflection level-of-detail associated with visible glint particles based on the viewing distance relative to the material surface inferred from the viewing parameters 232.

The glint particle surface integrator 236 then calculates the combined contribution of visible particles to each pixel, taking into account factors such as particle orientation, viewing angle, and lighting conditions described by the viewing parameters 232. This glint particle surface integrator 236 allows for the accurate representation of complex materials with color-dependent reflective properties, such as holographic finishes, opal-like stones, or modern automotive paints with color-shifting effects. The alias-free glint data 238 produced by the glint particle surface integrator 236 is then passed to the rendering interface 228.

The rendering interface 228 receives the alias-free glint data 238 at a glint data converter 240. The glint data converter 240 is optional and configured to transform the alias-free glint data 238 into a format compatible with various rendering engines, e.g., the rendering module 212. The glint data converter 240 outputs the renderable glint data 214 based on the alias-free glint data 238 obtained from the glint model 126. When combine with importance sampling techniques designed for the glint model 126, the rendering interface 228 enables efficient rendering of glint effects.

The procedural generation techniques do not utilize storage to maintain particle information. The system 216 enables efficient creation of nuanced and accurate material appearances across a range of 3D applications where glints appear, addressing challenges of conventional approaches to glint rendering.

FIG. 3 illustrates a block diagram of an implicit grid structure 300 used for material glint generation. The implicit grid structure 300 is a 4D grid structure that includes a hemisphere space 302 and a texture space 304, representing different aspects of glint particle distribution.

Two dimensions of the implicit grid structure 300 correspond to spatial distributions, and the other two dimensions correspond to angular distributions. The implicit grid structure 300 conveys the angular and spatial distributions at two fixed scales, a first scale labeled MIP N+1 306 represents glint particle information at a first level of detail, and a second scale labeled MIP N 308 represents glint particle information at a second level of detail.

The texture space 304 defines spatial distributions of the glint particles corresponding to the two fixed levels of detail MIP N+1 306 and MIP N 308. The hemisphere space 302 defines angular distributions of glint particles corresponding to the two fixed levels of detail MIP N+1 306 and MIP N 308. If the latter is not exact and the implicit grid structure 300 covers the square [−1,1]², particles with directions that fall outside of the disk of the hemisphere space 302 are discarded.

The glint normal distribution function 224 utilizes two factors to determine the contribution of a particle (xᵢ, μᵢ) from the glint model 126, including proximity in space to the shading location x 312, and proximity in angle to the transformed half vector ωₕ 310. The relative influence of the spatial and angular distances varies with covariances Σ and σ, and the process adapts to efficiently enumerate the particles that are close to the desired position 312 and half vector 310.

The glint positions of the glint model 126 are procedural and generated with a standard pseudorandom number generator seeded with the cell index to the implicit grid structure 300 such that no storage is consumed. The user selects (e.g., based on the glint input 122) a number of N particles per unit area of texture space, from which the modeling tool 116 computes a base spatial resolution of Sₒ=[√N]. The corresponding angular resolution is Aₒ=1. On the base level, the spatial localization is the highest possible and the angular is lowest: each cell has one particle with a seemingly random orientation, which is preferred for extreme closeups, where a queried pixel covers less than a cell.

The base level has Sₒ²Aₒ²≈N particles. To be able to efficiently enumerate the particles close by in angle, the equivalent of higher MIP levels with lower spatial but higher angular resolution are produced. Each level halves the spatial resolution and doubles the angular resolution; Sₙ₊₁=Sₙ/2, Aₙ₊₁=2Aₙ. This keeps the total number of particles the same for each level. The positions of the particle for the cell with index (i,j,k,l) at level n is then:

$${x}_{ijkl}^{n} = \frac{[ \begin{matrix}i \\ j\end{matrix} ] + {r}_{1}}{{S}_{n}} , \qquad ( 7 )$$

$${μ}_{ijkl}^{n} = \frac{[ \begin{matrix}k \\ l\end{matrix} ] + {r}_{2}}{{A}_{n}} ,$$

where x and μ are the spatial and angular positions, r₁ and r₂ are pseudorandom vectors distributed according to U[0,1]², seeded with the cell index.

To handle varying view distances, a level of detail solution is introduced that balances resolution in the spatial and angular domains. To be able to only consider nearby particles of the shading location (both spatially and in orientation), that means the grids spatial and angular resolutions is related to how confident a glint is to be found that reflects light for this shading location. In an extreme close-up, a pixel covers a small portion of a surface, so a spatial resolution is large as there is little uncertainty in the glint locations. However, because glints have random orientations, there is uncertainty in glint ability to reflect light and the angular resolution is therefore low. Further away, a pixel covers a larger portion of the surface, and the spatial resolution decreases as the uncertainty of the glints location increases. But because pixels encompass a lot of seemingly random-oriented particles, the angular resolution can be larger as at least some of the particles are likely to reflect light.

When viewed from sufficiently far away, many particles may fall under both the spatial and the angular filter. In this case, the exact positions and orientations are no longer significant, and using their expected contribution works well. Summing over uniformly distributed particles with the same standard deviation is the same as integrating over the space:

$$E {\sum }_{i}^{N} p ω , {μ}_{i} , σ = {\int }_{{R}^{2}} p ( ω , x , σ ) dx \qquad ( 8 )$$

To avoid double-counting the close by particles, the integral over that area is subtracted. Note that the correction term is applied in the angular direction; the spatial-angular tradeoff is chosen such that the small spatial neighborhood is large enough (that is, the contribution from particles outside of the neighborhood is negligible.) The number of angular neighbors considered is a performance-quality tradeoff that can be adjusted. For example, 4 neighbors is sufficient for many cases.

As demonstrated by Deliot and Belcour, linear blending of glint distributions is not desirable; the appearance at the midpoint of interpolation is that of twice as many glints with half the intensity, which is visually distinct from the endpoints. To this end, the implicit grid structure 300 uses a linearly blended weight for a per-particle roulette feature 314, so that on expectation linear blending is achieved but single glints get quickly enabled and disabled instead of being smoothly blended. To keep the appearance smooth under animation, the roulette feature 314 is slightly smoothed; the Heaviside function of the exact roulette feature 314 is replaced by a function that goes from zero to one rapidly but smoothly. The roulette feature 314 blending is used between levels of detail, e.g., MIP N 308 and MIP N+1 306. This technique is compatible without UVs via triplanar mapping. The same roulette term is then used to blend between the differently oriented planes.

On the left, the MIP N+1 306 has greater spatial resolution in the texture space 304 than the MIP N 308 and lower spatial resolution in the hemisphere space 302 than the MIP N 308. The roulette feature 314 enables efficient conversion to an intermediary level between the two fixed scales MIP N+1 306 and MIP N 308, in both the hemisphere space 302 and texture space 304. This allows the system to adapt the level of detail and tradeoff between spatial and angular resolution as needed based on viewing conditions.

The implicit grid structure 300 facilitates use of the glint normal distribution function 224, glint model 126, and viewing parameters 232 to generate alias-free glint data 238. The glint model interface 226, visible particle detector 234, and glint particle surface integrator 236 utilize the implicit grid structure 300 to efficiently process and render glint effects.

For example, the visible particle detector 234 uses the implicit grid structure 300 to determine which glint particles are visible based on the viewing parameters 232. The glint particle surface integrator 236 then calculates contributions from those visible particles using the spatial and angular distributions defined by the implicit grid structure 300. The rendering interface 228 and glint data converter 240 use the processed glint data 238, 214 to generate final rendered outputs depicting realistic glint effects.

Overall, the implicit grid structure 300 provides a flexible and computationally efficient framework for representing and processing glint particles across different scales and perspectives, without storing or representing each individual particle.

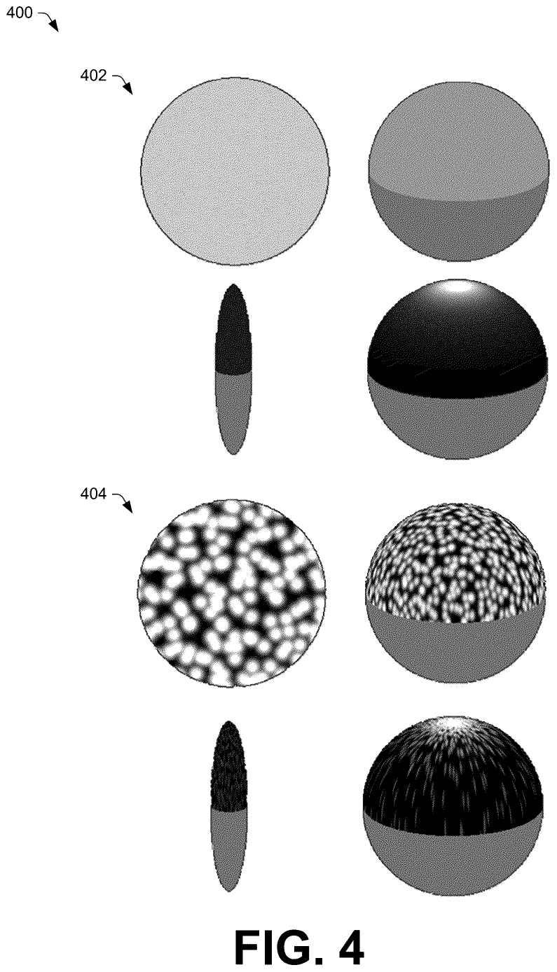

FIG. 4 illustrates a comparison 400 between material surface representations depicting non-glint and glint characteristics. The comparison 400 includes a non-glint representation 402 showing a base model with a smooth surface having consistent reflectance, and a glint representation 404 depicting a glint model with a speckled or sparkly surface appearance. The non-glint representation 402 displays uniform shading across four different spherical surfaces, including a basic microfacet BRDF with normal distribution, two anisotropic variants with elongated highlights, and a version with an additional clear coat layer. In contrast, the glint representation 404 exhibits a speckled or sparkly material finish with distinct bright spots in shading across the same four spherical surfaces. The glint representation 404 is generated based on the non-glint representation 402 to maintain an overall similar shape while introducing high-frequency variations within the consistent reflectance pattern of the otherwise smooth surface. This comparison demonstrates how the glint model introduces localized reflections that simulate embedded particles within the material surface, creating a more complex and realistic appearance compared to the uniform shading of the base model.

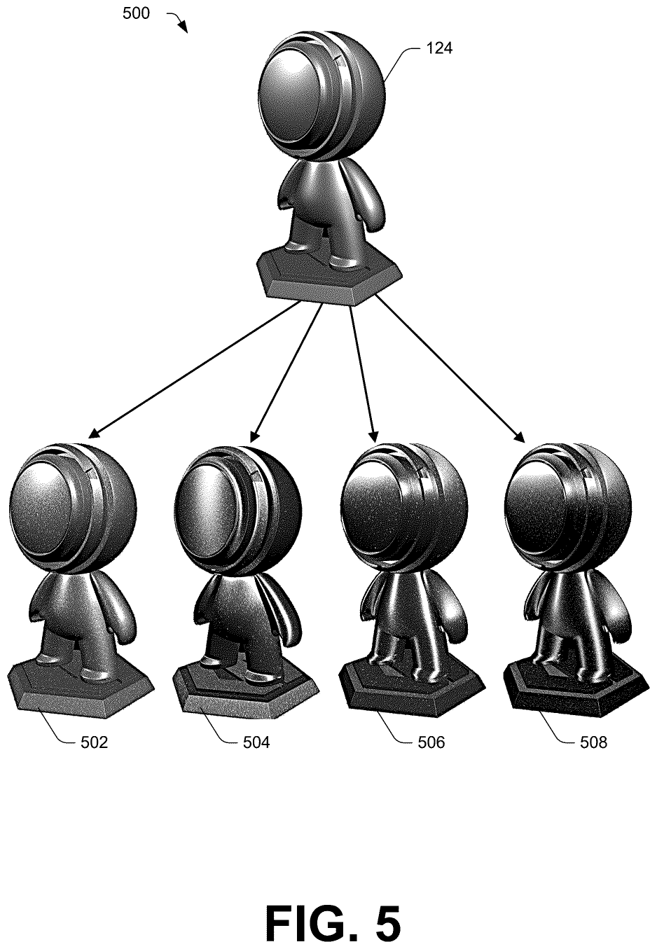

FIG. 5 illustrates example glint effects 500 applied to an object model using material glint generation for digital content. The glint effects 500 depict different glint effects applied to an object model 124 to generate four variations of the glint model 126. Each of the variations of the glint model 126 depicts a different glint effect. The glint parameters 206 can control characteristics such as glint density, roughness, color, size distribution, and spatial variation to achieve diverse visual effects. For example, parameters 206 may specify the number of glint particles per unit area, the relative brightness of glints, statistical distributions for glint sizes, and functions defining how glint properties vary across the surface. This allows control over the appearance of materials like metallic car paint, glittery fabrics, or natural surfaces with complex light-scattering properties.

The modeling tool 116 can interpolate between parameter sets to transition between different glint styles, enabling dynamic glint effects that respond to changing viewing conditions or artistic direction. For example, a first glint model 502 shows a scattered glint effect with small reflective points distributed across the surface. The second glint model 504 displays a more concentrated glint pattern with medium-sized reflective areas. The third glint model 506 demonstrates a broader glint distribution with larger reflective regions. The fourth glint model 508 exhibits a darker surface treatment with subtle glint effects. The glint parameters 206 used to generate these variations may include settings for indicating one or more of a scattered glint effect, concentrated glint pattern, broad glint distribution, and faint glint effect. By adjusting the parameters 206, the modeling tool 116 is operable to produce a range of glint appearances.

FIG. 6 illustrates a flowchart of a process 600 for using material glint generation for digital content, according to aspects of the present disclosure. The process 600 includes several blocks that demonstrate the workflow for analyzing and selecting materials in 3D models. In various examples, the process 600 is performed by the computing device 102, the content processing system 104, the modeling tool 116, and so forth, alone or in combination with performing aspects of a process 700, as depicted in FIG. 7.

The process 600 begins at block 602, where a base model 124 representing a material surface of a digital object is obtained. The modeling tool 116, for instance, loads a 3D model of an object with potentially reflective or glittery surfaces, such as vehicles, clothing, or jewelry. The base model 124 represents the initial geometry and surface properties of the digital object before glint effects are applied.

The process 600 then proceeds to block 604, where one or more glint parameters indicating glint effects applied to the material surface are received. For example, the modeling tool 116 receives input 118 specifying characteristics such as glint density, color, roughness, or distribution pattern. These parameters 206 convey visual phenomena that simulate localized reflections or sparkles resulting from embedded particles within the material surface.

Following block 604, the process 600 moves to block 606, where a glint model 126 of the glint effects is generated by integrating a plurality of glint particles within the material surface based on the glint parameters. The modeling tool 116 defines an implicit 4D grid structure 300 representing spatial and angular distributions of the glint particles at different scales. The modeling tool 116 applies a roulette feature 314 to blend between resolutions (scales), enabling efficient level-of-detail management.

The glint model 126 generated in block 606 is derived from a BRDF based on the base model 124. The modeling tool 116 modifies the NDF of the BRDF by introducing high-frequency variations to each of the glint particles to generate the glint normal distribution function 224. The approach allows the system to maintain compatibility with existing physically-based rendering workflows while improving realism by introducing more varied glint effects.

The process 600 concludes at block 608, where a rendered image 128 of the digital object is rendered using the glint model 126, depicting reflections from visible glint particles integrated within the material surface. The modeling tool 116 processes the glint model 126 to calculate how light interacts with the glint particles at different angles and scales. The rendered image 128 displays the digital object with glint effects that vary based on viewing angle and distance, including under any specified lighting conditions, with or without light, with or without color, etc.

Following block 608, the process 600 includes additional steps to support interactive visualization and adjustment of glint effects. These steps, while not explicitly shown in FIG. 6, are implemented in some examples of the process 600.

After block 608, the modeling tool 116 outputs the rendered image 128 for display at the display device 112. The rendered image 128 previews the reflections from visible glint particles at a specific viewing angle and from a particular viewing distance relative to the material surface. The rendered image 128 is output for display at the display device 112 being used to preview the reflections at a viewing angle and from a viewing distance relative the material surface.

Next, the modeling tool 116 receives user inputs through the user interface 110 that change at least one of the viewing angle or the viewing distance. These inputs allow users to interactively explore the glint effects from different perspectives. In response to the user inputs, the modeling tool 116 renders an updated image of the digital object at a different viewing angle or from a different viewing distance. This updated image depicts different reflections from different visible glint particles integrated within the material surface.

The modeling tool 116 recalculates which glint particles are visible from the new perspective and how they contribute to the overall appearance of the material surface. The modeling tool 116 outputs the updated image for display at the display device 112, allowing the user to observe how the glint effects change with different viewing parameters, and demonstrating rapid feedback and procedural adjustment of glint effects. These additional optional steps of the process 600 enhance a user ability to visualize and fine-tune glint effects across various viewing conditions.

FIG. 7 illustrates a flowchart of another process for using material glint generation for digital content, according to aspects of the present disclosure. The process 700 includes several blocks that demonstrate the workflow for analyzing and selecting materials in 3D models. In various examples, the process 700 is performed by the computing device 102, the content processing system 104, the modeling tool 116, and so forth, alone or in combination with performing aspects of the process 600.

The process 700 begins at block 702, which generates a glint model 126 based on a base model 124 of a digital object and glint parameters. For example, the modeling tool 116 integrates a plurality of glint particles within a material surface of the digital object using the glint input 122 received through the user interface 110.

The process 700 continues at block 704, which defines a four dimensional grid structure that represents spatial and angular distributions of the glint particles at multiple levels of detail. In variations, the modeling tool 116 implicitly defines the 4D grid structure 300.

The process 700 proceeds to block 706, which outputs a first glint preview that depicts first reflections from first visible glint particles integrated within the material surface defined by the four dimensional grid structure. For example, the rendering module 212 generates a rendered image 128 showing the digital object with glint effects that vary based on viewing angle and distance. In variations, the first glint preview resembles the glint effects 500 shown in FIG. 5, such as the first glint model 502 or second glint model 504.

The process 700 advances to block 708, which receives user inputs requesting a second glint preview at a different viewing angle or a different viewing distance relative to the material surface. For example, the user interface module 204 receives input commands 230 through the input/output interfaces 808 of the computing device 802, specifying changes to the viewing parameters 232. In variations, the user inputs modify the glint parameters, such as glint density, glint color, glint roughness, or glint distribution pattern.

The process 700 concludes at block 710, which outputs the second glint preview based on the user inputs that depict second reflections from second visible glint particles integrated within the material surface defined by the four dimensional grid structure. For example, the rendering module 212 generates an updated rendered image 128 showing the digital object with modified glint effects based on the new viewing angle or distance. In variations, the second visible glint particles and the first visible glint particles include different quantities of the glint particles, as determined by the visible particle detector 234.

The process 700 enables interactive adjustment and visualization of glint effects from various perspectives, addressing limitations of static rendering approaches that produce inconsistent results across different scenes and viewing conditions. By defining an implicit grid structure to facilitate integrating contributions of glint effects based on the generated glint model 126, the process 700 provides a computationally efficient method for simulating complex micro-scale reflective features in digital content.

### Example System and Device

FIG. 8 illustrates an example system 800 including various components of an example device usable as any type of computing device as described and/or utilized with reference to FIGS. 1-7 to implement examples of the techniques described herein. FIG. 8 illustrates an example system 800 generally, which includes an example computing device 802 that is representative of one or more computing systems and/or devices that implement the various techniques described herein. This is illustrated through inclusion of the modeling tool 116. The computing device 802 is configurable, for instance, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. In one or more examples, a system bus includes any one, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including the hardware elements 810, which are configurable as processors, functional blocks, and so forth. This includes implementation in hardware as an application specific integrated circuit or other logic device formed using one or more semiconductors. The hardware elements 810 are not limited by the materials that form the hardware elements 810, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 806 is storage media illustrated as including memory/storage 812. The memory/storage 812 represents memory/storage capacity associated with one or more computer-readable media. The memory/storage 812 is configured as a memory component, for example, which is configured to store the digital content 106. The memory/storage 812 includes volatile media (such as random access memory (RAM)) and/or nonvolatile media, such as read-only memory (ROM), Flash memory, optical disks, magnetic disks, and so forth. The memory/storage 812 includes fixed media (e.g., RAM, ROM, a fixed hard drive, and so on) as well as removable media, e.g., Flash memory, a removable hard drive, an optical disc, and so forth. The computer-readable media 806 is configurable in a variety of other ways as further described below.

Input/output interface(s) 808 are representative of functionality to allow a user to enter commands and information to computing device 802 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 810 include a processing device coupled to the memory component implemented by the memory/storage 812 to perform operations of the modeling tool 116. The operations, when executed, cause the processing device implemented by the hardware elements 810 to render a scene using the digital content 106 stored in the memory/storage 812.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (e.g., at least one computing device 802 and/or processing systems 804) to implement techniques, modules, and examples described herein.

The techniques described herein are supported by various configurations of the computing device 802 and are not limited to the specific examples of the techniques described herein. This functionality is also implementable or partially implementable through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data utilized while computer processing is executed on servers that are remote from the computing device 802. In at least one example, the resources 818 include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device example, implementation of functionality described herein is distributable throughout the system 800. The functionality is implementable in part on the computing device 802 as well as via the platform 816 that abstracts the functionality of the cloud 814.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method comprising:
obtaining, by a processing device, a base model representing a material surface of a digital object;
receiving, by the processing device, one or more glint parameters indicating glint effects applied to the material surface conveying visual phenomena that simulate localized reflections or sparkles resulting from embedded particles within the material surface;
generating, by the processing device, a glint model of the glint effects by integrating a plurality of glint particles within the material surface based on the glint parameters; and
rendering, by the processing device and using the glint model, an image of the digital object depicting reflections from visible glint particles integrated within the material surface.

2. The method of claim 1, further comprising:
outputting, by the processing device, the image for display at a display device that previews the reflections at a viewing angle and from a viewing distance relative the material surface.

3. The method of claim 2, further comprising:
responsive receiving user inputs that change at least one of the viewing angle or the viewing distance, rendering, by the processing device, an updated image of the digital object at a different viewing angle or from a different viewing distance depicting different reflections from different visible glint particles integrated within the material surface.

4. The method of claim 1, wherein the base model comprises a Bidirectional Reflectance Distribution Function including:
a diffuse component representing scattered light reflected from the material surface in multiple directions; and
a specular component representing reflected light in a specific direction based on a Normal Distribution Function defining the glint particles as a statistical distribution of microfacet normal properties on the material surface.

5. The method of claim 4, wherein the generating includes:
modifying the Normal Distribution Function by introducing high-frequency variations to each of the glint particles described by the specular component; and
adjusting the Normal Distribution Function by changing particle characteristics of each of the glint particles based on the glint parameters.

6. The method of claim 5, wherein the particle characteristics of each of the glint particles include at least one of a glint density, a glint color, a glint roughness, or a glint distribution pattern.

7. The method of claim 1, wherein the generating includes defining an implicit multi dimensional grid structure that represents spatial and angular distributions of the glint particles in multiple levels of detail.

8. The method of claim 7, wherein two dimensions of the multi dimensional grid structure represent position distributions of the glint particles at two fixed levels of detail, and two other dimensions represent angular distributions of the glint particles at the two fixed levels of detail.

9. The method of claim 8, further comprising:
converting between the two fixed levels of detail by applying a roulette feature that blends the position distributions and the angular distributions between the two fixed levels of detail.

10. The method of claim 1, wherein the rendering includes adjusting a reflection level-of-detail associated with the visible glint particles based on a viewing distance relative the material surface.

11. A method comprising:
generating, by a processing device, a glint model based on a base model of a digital object and glint parameters that integrates a plurality of glint particles within a material surface of the digital object;
defining a multi dimensional grid structure that represents spatial and angular distributions of the glint particles at multiple levels of detail;
outputting, by the processing device, a first glint preview that depict first reflections from first visible glint particles integrated within the material surface defined by the multi dimensional grid structure;
receiving, by the processing device, user inputs requesting a second glint preview at a different viewing angle or a different viewing distance relative to the material surface; and
outputting, by the processing device, the second glint preview based on the user inputs that depict second reflections from second visible glint particles integrated within the material surface defined by the multi dimensional grid structure.

12. The method of claim 11, wherein the second visible glint particles and the first visible glint particles include different quantities of the glint particles.

13. The method of claim 11, wherein the generating includes:
converting between the multiple levels of detail by applying a roulette feature that blends the spatial and angular distributions between two fixed levels of detail.

14. The method of claim 11, wherein the outputting the second glint preview includes adjusting a reflection level-of-detail associated with the visible glint particles based on the viewing distance relative to the material surface.

15. The method of claim 11, wherein the glint model is derived from a Bidirectional Reflectance Distribution Function based on the base model by introducing high-frequency variations to each of the glint particles described by a Normal Distribution Function based on the base model.

16. A system comprising:
a memory component; and
one or more processing devices coupled to the memory component to perform operations including:
obtaining surface characteristics of a material surface of a digital object;
receiving one or more glint parameters of glint effects applied to the material surface;
generating a glint model of the glint effects by integrating a plurality of glint particles within the material surface based on the glint parameters and the surface characteristics; and
rendering, using the glint model, an image of the digital object depicting reflections from visible glint particles integrated within the material surface.

17. The system of claim 16, wherein the surface characteristics are obtained from a base model of the material surface of the digital object and include at least one of roughness of the material surface, reflectivity of the material surface, or curvature of the material surface.

18. The system of claim 17, wherein the generating includes at least one of:
determining a distribution of the glint particles based on the roughness of the material surface;
adjusting a reflectivity of the glint effects based on the reflectivity of the material surface; or
modifying orientations of the glint particles based on the curvature of the material surface.

19. The system of claim 16, wherein the glint parameters indicate at least one of a scattered glint effect, a concentrated glint pattern, a broad glint distribution, or a faint glint effect.

20. The system of claim 16, wherein the generating includes:
defining a multi-dimensional grid structure that represents spatial distributions of the glint particles at multiple fixed scales, and angular distributions of the glint particles at the multiple fixed scales.
